(19) United States
(12) Patent Application Publication
(10) Pub. No.: US 2025/0212151 A1
(43) Pub. Date: Jun. 26, 2025

(54) APPARATUS AND METHOD FOR TRANSMITTING LATENCY-SENSITIVE DATA IN WIRELESS LOCAL AREA NETWORK (WLAN) SYSTEM

(71) Applicant: SAMSUNG ELECTRONICS CO., LTD., Suwon-si (KR)

(72) Inventors: Myeongjin KIM, Suwon-si (KR); Jinmin KIM, Suwon-si (KR); Eunsung JEON, Suwon-si (KR); Chulho CHUNG, Suwon-si (KR)

(73) Assignee: SAMSUNG ELECTRONICS CO., LTD., Suwon-si (KR)

(21) Appl. No.: 18/970,454

(22) Filed: Dec. 5, 2024

(30) Foreign Application Priority Data
Dec. 21, 2023 (KR) 10-2023-0188829
Apr. 16, 2024 (KR) 10-2024-0050913

(51) Int. Cl. H04W 60/04; H04W 72/04; H04W 72/121

(52) U.S. Cl. CPC H04W 60/04; H04W 72/04; H04W 72/121

(57) ABSTRACT

An operation method in a wireless network includes: receiving, at a first apparatus, an association request from a second apparatus; in response to the association request, transmitting, from the first apparatus to the second apparatus, an association response including information about the second apparatus; and transmitting, from the first apparatus to the second apparatus, a physical layer protocol data unit (PPDU), which includes first information about whether first data is to be transmitted and second information about an apparatus that is to receive the first data transmitted via a resource unit capable of transmitting the first data.

### CROSS-REFERENCE TO RELATED APPLICATION

This application is based on and claims priority under 35 U.S.C. § 119 to Korean Patent Application No. 10-2023-0188829, filed on Dec. 21, 2023, and Korean Patent Application No. 10-2024-0050913, filed on Apr. 16, 2024, in the Korean Intellectual Property Office, the disclosures of which are incorporated by reference herein in their entireties.

### BACKGROUND

One or more embodiments of the disclosure relate to wireless communication, and more particularly, to an apparatus and method for transmitting latency-sensitive data in a wireless local area network (WLAN) system.

WLAN is a technique of connecting two or more devices by a radio signal transfer method, which may be based on Institute of Electrical and Electronics Engineers (IEEE) 802.11 standards. The 802.11 standards have advanced to 802.11b, 802.11a, 802.11 g, 802.11n, 802.11ac, 802.11ax, and the like to support a transmission rate of up to 1 Gbyte/s based on orthogonal frequency-division multiplexing (OFDM) technology.

In 802.11ac, data may be simultaneously transmitted to a large number of users through multi-user multi-input multi-output (MU-MIMO) technology. In 802.11ax, which is referred to as High Efficiency (HE), multiple access is implemented by dividing and providing available subcarriers to users by using orthogonal frequency-division multiple access (OFDMA) technology as well as MU-MIMO technology. In this way, WLAN systems, to which 802.11ax is applied, may effectively support communication in dense areas and outdoor areas.

In 802.11be, which is referred to as Extremely High Throughput (EHT), research is directed to supporting a 6 GHz unlicensed frequency band, using a bandwidth of 320 MHz at most per channel, introduction of Hybrid Automatic Repeat and Request (HARQ), supporting 16×16 MIMO at most, and the like. In this way, next-generation WLAN systems are expected to effectively support low latency and ultra-high-speed transmission, like New Radio (NR) that is a 5G technology.

Such WLAN techniques may be used for services interacting with environments in real time, such as augmented reality or robot control. Data used for such real-time services may be latency-sensitive data that needs to be transmitted, with minimum latency, to other devices. Therefore, various methods are being studied to allow latency-sensitive data to be quickly transmitted in WLAN systems.

### SUMMARY

Various embodiments of the disclosure provide an apparatus and method capable of quickly transmitting latency-sensitive data in a wireless network such as a wireless local area network (WLAN) system.

According to an aspect of one or more embodiments, there is provided an operation method in a wireless network, the operation method including: receiving, at a first apparatus, an association request from a second apparatus; in response to the association request, transmitting, from the first apparatus to the second apparatus, an association response including information about the second apparatus; and transmitting, from the first apparatus to the second apparatus, a physical layer protocol data unit (PPDU), which includes first information about whether first data is to be transmitted and second information about an apparatus that is to receive the first data transmitted via a resource unit capable of transmitting the first data.

According to another aspect of one or more embodiments, there is provided an operation method in a wireless network, the operation method including: transmitting an association request from a second apparatus to a first apparatus; in response to the association request, receiving, at the second apparatus from the first apparatus, an association response including information about the second apparatus; and receiving, at the second apparatus from the first apparatus, a physical layer protocol data unit (PPDU), which includes first information about whether first data is to be transmitted and second information about an apparatus that is to receive the first data transmitted via a resource unit capable of transmitting the first data.

According to still another aspect of one or more embodiments, there is provided a first apparatus configured to communication with a second apparatus in a wireless network, the first apparatus including: a processing circuitry configured to generate a first signal field and a second signal field, the first signal field including a field indicating whether first data is to be transmitted, and the second signal field including a field indicating information about allocation of a resource unit, a field indicating that the first data is to be transmitted via the resource unit, and a field indicating information about an apparatus that is to receive the first data transmitted via the resource unit capable of transmitting the first data; and a transceiver configured to transmit, to the second apparatus, a physical layer protocol data unit (PPDU) including the first signal field and the second signal field.

### BRIEF DESCRIPTION OF DRAWINGS

Embodiments will be more clearly understood from the following detailed description taken in conjunction with the accompanying drawings in which:

FIG. 1 illustrates a wireless communication system according to one or more embodiments;

FIG. 2 illustrates a wireless communication system according to one or more embodiments;

FIG. 3 illustrates an apparatus according to one or more embodiments;

FIG. 4 is a flowchart illustrating an operation method of a wireless communication system, according to one or more embodiments;

FIG. 5 illustrates an example of a physical layer protocol data unit (PPDU) transmitted by an access point, according to one or more embodiments;

FIG. 6 illustrates an LS subfield transmitted by an access point, according to one or more embodiments;

FIG. 7 illustrates an example of a universal signal (U-SIG) field in a PPDU transmitted by an access point, according to one or more embodiments;

FIG. 8 illustrates an example of an ultra-high reliability signal (UHR-SIG) field in a PPDU transmitted by an access point, according to one or more embodiments;

FIG. 9 illustrates an example of a common field of a UHR-SIG field in a PPDU transmitted by an access point, according to one or more embodiments;

FIG. 10 illustrates an example of a user field of a UHR-SIG field in a PPDU transmitted by an access point, according to one or more embodiments;

FIG. 11 illustrates respective examples of a station identification (ID) and a group ID, which are allocated to each of a plurality of stations in a wireless communication system, according to one or more embodiments;

FIG. 12 illustrates an example of a resource unit configuration when the bandwidth allocated to a wireless communication system is 80 MHz, according to one or more embodiments;

FIG. 13 illustrates an example of a UHR-SIG field in a PPDU transmitted by an access point, when a resource unit configuration is the same as the example of FIG. 12;

FIG. 14 illustrates an example of transmitting an inserted PPDU through a PPDU being transmitted by an access point, when a resource unit configuration is the same as the example of FIG. 12;

FIG. 15 illustrates an example of an inserted PPDU transmitted by an access point, according to one or more embodiments;

FIG. 16 is a flowchart illustrating an operation method of an access point, according to one or more embodiments;

FIG. 17 is a flowchart illustrating a method, performed by an access point, of transmitting an inserted PPDU, according to one or more embodiments;

FIG. 18 is a flowchart illustrating an operation method of a station, according to one or more embodiments; and

FIG. 19 illustrates examples of an apparatus for wireless communication, according to one or more embodiments.

### DETAILED DESCRIPTION

Hereinafter, embodiments of the disclosure will be described in detail with reference to the accompanying drawings. It is to be understood that the embodiments described herein are non-limiting example embodiments, and thus, the disclosure is not limited thereto and may be realized in various other forms.

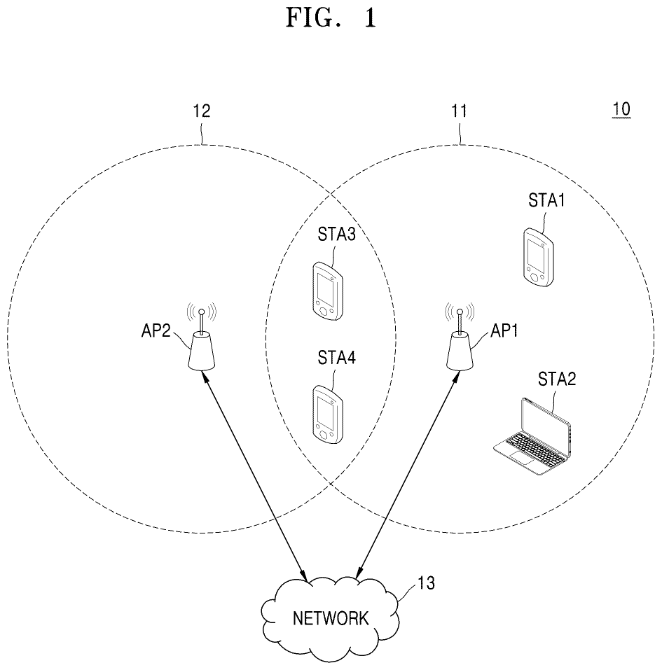

FIG. 1 illustrates a wireless communication system according to one or more embodiments.

The wireless communication system 10 shown in FIG. 1 may be an example of a wireless local area network (WLAN) system.

Although wireless communication systems based on orthogonal frequency division multiplexing (OFDM) or orthogonal frequency division multiplexing access (OFDMA), and IEEE 802.11 standards are referred to herein to describe the embodiments, it would be understood by those of ordinary skill in the art that the disclosure may be modified without departing from the scope of the disclosure and may be applied to any other communication systems (for example, cellular communication systems, such as Long-Term Evolution (LTE), LTE-Advanced (LTE-A), New Radio (NR), Wireless Broadband (WiBro), and Global System for Mobile communication (GSM) systems, or short-range communication systems, such as Bluetooth and Near Field Communication (NFC) systems) having similar technical backgrounds and channel types.

In addition, various functions described below may be implemented or supported by artificial intelligence (AI) technology or by one or more computer programs, and each of the programs includes computer-readable program code and is implemented on a computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as read-only memory (ROM), random access memory (RAM), hard disk drives, compact discs (CDs), digital video disks (DVDs), or any other types of memory, which may be accessed by computers. A “non-transitory” computer-readable medium does not include wired, wireless, optical, or other communication links for transmitting temporary electrical or other signals. Non-transitory computer-readable media include media in which data may be permanently stored, and media in which data may be stored and overwritten afterward, such as rewritable optical disks or erasable memory devices.

In various embodiments described below, a hardware approach is described as an example. However, because various embodiments of the disclosure include a technique using both hardware and software, the embodiments do not exclude software-based approaches.

In addition, as used herein, terms referring to control information, terms referring to entries, terms referring to network entries, terms referring to messages, terms referring to components of an apparatus, and the like are provided as examples for convenience of descriptions. Therefore, the disclosure is not limited to the terms described below, and other terms having equivalent technical meanings may be used.

Referring to FIG. 1, the wireless communication system 10 may include a first access point AP1, a second access point AP2, a first station STA1, a second station STA2, a third station STA3, and a fourth station STA4. The first access point AP1 and the second access point AP2 may access a network 13 including the Internet, an internet protocol (IP) network, or any other network. The first access point AP1 may provide access to the network 13 to the first station STA1, the second station STA2, the third station STA3, and the fourth station STA4 within a first coverage area 11, and the second access point AP2 may provide access to the network 13 to the third and fourth stations STA3 and STA4 within a second coverage area 12. In some embodiments, the first access point AP1 and the second access point AP2 may communicate with at least one of the first station STA1, the second station STA2, the third station STA3, and the fourth station STA4, based on Wireless Fidelity (WiFi) or any other WLAN access technique or standards.

An access point may be referred to as a router, a gateway, or the like, and a station may be referred to as a mobile station, a subscriber station, a terminal, a mobile terminal, a wireless terminal, a user equipment, a user, or the like. The station may include a mobile device, such as a mobile phone, a laptop computer, a wearable device, or the like, or a stationary device, such as a desktop computer, a smart television (TV), or the like. Herein, the access point may be referred to as a first apparatus, and the station may be referred to as a second apparatus.

The access point (e.g., AP1 or AP2) may allocate at least one resource unit (RU) to at least one station (e.g., at least one of STA1 to STA4). The access point may transmit data via the at least one RU that is allocated, and the at least one station may receive the data via the at least one RU that is allocated. While, in 802.11ax, the access point may allocate only a single resource unit to the at least one station, the access point may allocate a multi-resource unit (MRU) including two or more RUs to the at least one station, in 802.11be (for example, Extremely High Throughput (EHT)) or next-generation IEEE 802.11 standards (for example, EHT+ or Ultra High Reliability (UHR)). For example, the first access point AP1 may allocate an MRU to at least one of the first station STA1, the second station STA2, the third station STA3, and the fourth station STA4, and may transmit data via the allocated MRU.

An association operation for an initial link setup may be performed between the access point (e.g., AP1 or AP2) and the at least one station (e.g., at least one of STA1 to STA4). The access point may receive an association request from the at least one station. The access point may transmit an association response to the at least one station, in response to the association request. Information regarding various capabilities of the access point and the at least one station (e.g., at least one of STA1 to STA4) may be transmitted through the association request and the association response.

The access point (e.g., AP1 or AP2) may transmit a physical layer protocol data unit (PPDU), in which data (e.g., payload) is included, to the at least one station (at least one of STA1 to STA4) for which the link setup has been completed through the association operation.

The disclosure may relate to, when latency-sensitive data (which is referred to as first data, hereinafter) to be transmitted with a minimum latency to another apparatus is generated in or received at the access point (e.g., AP1 or AP2), a method of transmitting the first data to the stations (e.g., STA1 to STA4) as quickly as possible. For example, a latency-sensitive data may refer to a data for alerting an accident in a network, e.g., home network.

In one or more embodiments, the access point (e.g., AP1 or AP2) may transmit an association response, which includes a group identification (ID) of the stations (e.g., STA1 to STA4), to the stations, in response to an association request. The group ID may be an ID indicating which RU is used by the access point (e.g., AP1 or AP2) to transmit the first data to the stations. When the access point receives the association request from the stations, the access point may allocate a group ID for the stations. The access point may transmit the group ID to the stations through the association response.

In one or more embodiments, the access point (e.g., AP1 or AP2) may transmit a PPDU, which includes a field indicating whether the first data is to be transmitted and a field indicating the group ID of a group including an apparatus that is to receive the first data transmitted via an RU capable of transmitting the first data. By doing this, the access point may notify the stations (e.g., STA1 to STA4) of whether the first data is able to be transmitted.

In one or more embodiments, when a request for transmission of the first data is generated, the access point (e.g., AP1 or AP2) may transmit an inserted PPDU including the first data via an RU corresponding to the group ID. By doing this, the first data may be quickly transmitted.

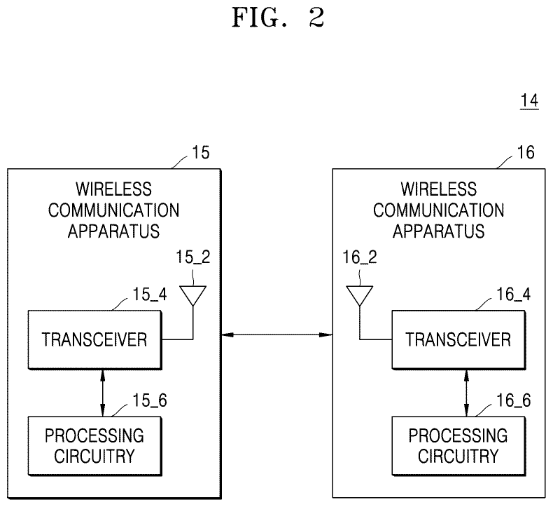

FIG. 2 is a block diagram illustrating a wireless communication system according to one or more embodiments.

Referring to FIG. 2, a wireless communication system 14 may include a first wireless communication apparatus 15 and a second wireless communication apparatus 16, which communicate with each other. Each of the first wireless communication apparatus 15 and the second wireless communication apparatus 16 in FIG. 2 may include any apparatus performing communication in the wireless communication system 14 and may be referred to as an apparatus for wireless communication. In some embodiments, each of the first wireless communication apparatus 15 and the second wireless communication apparatus 16 may include an access point (e.g., AP1 or AP2 of FIG. 1) or a station (e.g., STA1, STA2, STA3 or STA4 of FIG. 1) of a WLAN system.

The first wireless communication apparatus 15 may include an antenna 15_2, a transceiver 15_4, and processing circuitry 15_6. In some embodiments, the antenna 15_2, the transceiver 15_4, and the processing circuitry 15_6 may be included in one package (a semiconductor package including one or more chips) or may be respectively included in different packages (semiconductor packages including one or more chips). The second wireless communication apparatus 16 may also include an antenna 16_2, a transceiver 16_4, and processing circuitry 16_6, which may be included in one package or different provided packages. Hereinafter, repeated descriptions regarding the first wireless communication apparatus 15 and the second wireless communication apparatus 16 may be omitted.

The antenna 15_2 may receive a signal from the second wireless communication apparatus 16 and provide the signal to the transceiver 15_4, or may transmit, to the second wireless communication apparatus 16, a signal provided from the transceiver 15_4. In some embodiments, the antenna 15_2 may include a plurality of antennas for multiple-input multiple-output (MIMO). In addition, in some embodiments, the antenna 15_2 may include a phased array for beamforming.

The transceiver 15_4 may process a signal received from the second wireless communication apparatus 16 via the antenna 15_2 and may provide the processed signal to the processing circuitry 15_6. In addition, the transceiver 15_4 may process a signal processed at the processing circuitry 15_6 and may output the processed signal via the antenna 15_2. In some embodiments, the transceiver 15_4 may include an analog circuit, such as a low-noise amplifier, a mixer, a filter, a power amplifier, an oscillator, or the like. In some embodiments, the transceiver 15_4 may process a signal received from the antenna 15_2 and/or a signal received from the processing circuitry 15_6, based on control of the processing circuitry 15_6.

The processing circuitry 15_6 may extract information transmitted by the second wireless communication apparatus 16, by processing the signal received from the transceiver 15_4. For example, the processing circuitry 15_6 may extract information by demodulating and/or decoding the signal received from the transceiver 15_4. In addition, the processing circuitry 15_6 may generate a signal including information intended to be transmitted and may provide the signal to the transceiver 15_4. For example, the processing circuitry 15_6 may provide, to the transceiver 15_4, a signal generated by encoding and/or modulating data intended to be transmitted to the second wireless communication apparatus 16. In some embodiments, the processing circuitry 15_6 may include a programmable component, such as a central processing unit (CPU) and/or a digital signal processor (DSP), a reconfigurable component, such as a field programmable gate array (FPGA), or a component providing a fixed function, such as an intellectual property (IP) core. In some embodiments, the processing circuitry 15_6 may include a memory storing data and/or a series of instructions, or may access the memory.

Herein, performing operations by the transceiver 15_4 and/or the processing circuitry 15_6 may be simply referred to as performing the operations by the first wireless communication apparatus 15. Therefore, operations performed by an access point may be performed by a transceiver and/or processing circuitry in the access point, and operations performed by a station may be performed by a transceiver and/or processing circuitry in the station.

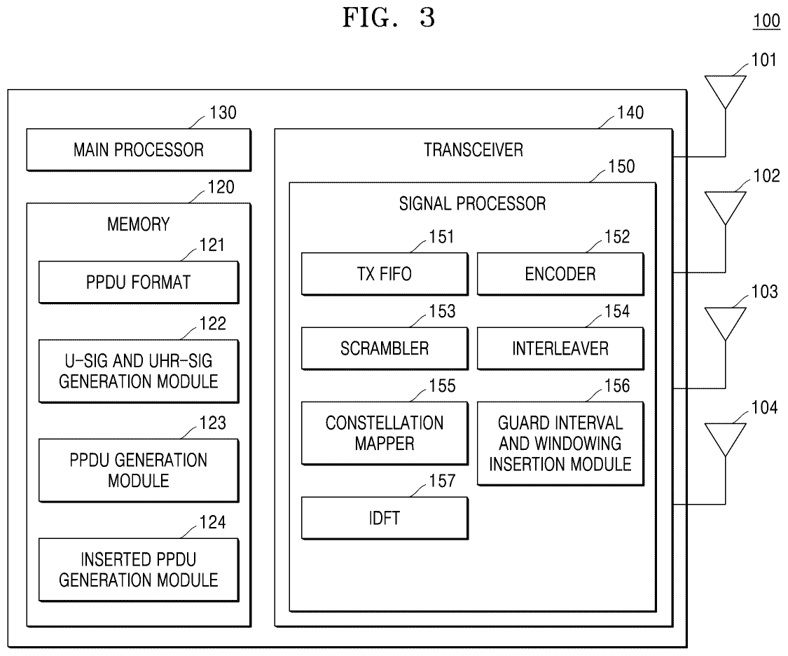

FIG. 3 is a block diagram illustrating an apparatus according to one or more embodiments.

An apparatus 100 of FIG. 3 may include an access point or a station, which includes a transceiver capable of performing data communication. For example, the apparatus 100 of FIG. 3 may be or include one of the access points (e.g., AP1 and AP2 of FIG. 1) and the stations (e.g., STA1, STA2, STA3, and STA4 of FIG. 1) and may be applied to, for example, a computer, a smartphone, a portable electronic device, a tablet, a wearable device, a sensor used for Internet-of-Things (IoT), or the like. Hereinafter, an example in which the apparatus 100 corresponds to an access point is described.

Referring to FIG. 3, the apparatus 100 may include a main processor 130, a memory 120, a transceiver 140, and antenna arrays 101 to 104. The main processor 130, the memory 120, the transceiver 140, and the antenna arrays 101 to 104 may be directly or indirectly connected to each other.

Specifically, the main processor 130 may control the memory 120 and the transceiver 140. The memory 120 may include a PPDU format 121, a universal signal (U-SIG) and ultrahigh reliability signal (UHR-SIG) generation module 122, a PPDU generation module 123, and an inserted PPDU generation module 124. For example, the U-SIG and UHR-SIG generation module 122, the PPDU generation module 123, and the inserted PPDU generation module 124 may each include pieces of code or instructions to be executed by the main processor 130.

In one or more embodiments, the main processor 130 may generate a PPDU based on the U-SIG and UHR-SIG generation module 122 and the PPDU generation module 123. In addition, the main processor 130 may generate an inserted PPDU based on the inserted PPDU generation module 124 for first data, while the PPDU is being transmitted.

A signal processor 150 may include various modules (e.g., various transmit path modules) configured to generate each section of a PPDU or each section of various communication transmission units. Although FIG. 3 illustrates one or more embodiments in which the signal processor 150 is included in the transceiver 140, because this is only an example, the disclosure is not limited thereto, and the signal processor 150 may be implemented as a component separate from the transceiver 140.

Specifically, the signal processor 150 may include a transmit first-in-first-out (TX FIFO) 151, an encoder 152, a scrambler 153, an interleaver 154, a constellation mapper 155 (which may generate, for example, a quadrature amplitude modulation (QAM) symbol), an inversed discrete Fourier transformer (IDFT) 157, and a guard interval and windowing insertion module 156 (which may insert a guard interval in a frequency and modify a signal through windowing to reduce interference in a spectrum, for example).

For reference, the transceiver 140 may include the above-described components as shown in FIG. 3 and other components well known to those of ordinary skill in the art. In addition, these components may be executed by a method well known to those of ordinary skill in the art by using hardware, firmware, software logic, or a combination thereof. For example, the components included in the signal processor 150 may be implemented by software modules stored in an internal memory or the memory 120 and executed by a processor, e.g., a digital signal processor (DSP) included in the signal processor 150.

FIG. 3 illustrates only an example of the apparatus 100, and the disclosure is not limited thereto. For example, various modifications may be made to FIG. 3.

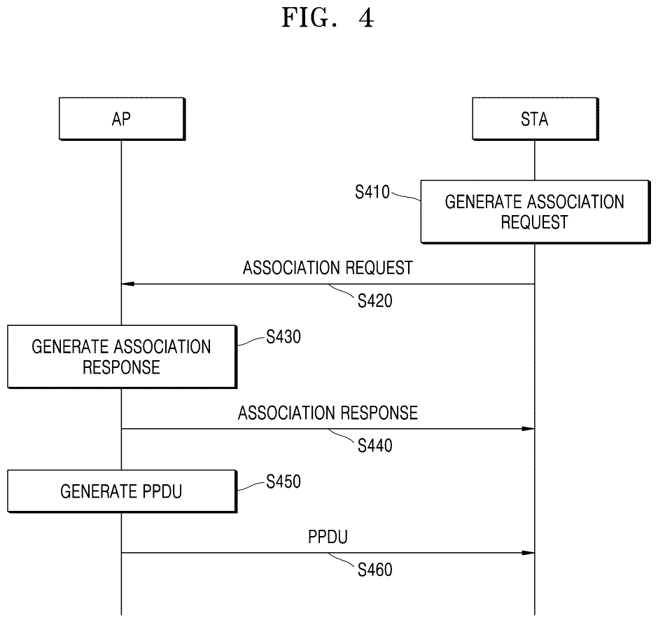

FIG. 4 is a flowchart illustrating an operation method of a wireless communication system, according to one or more embodiments.

Referring to FIG. 4, in operation S410, a station STA (e.g., STA1, STA2, STA3 or STA4 of FIG. 1) may generate an association request. The association request may be a request, which is transmitted by the station STA, for an initial link setup with an access point AP (e.g., AP1 or AP2 of FIG. 1) for an access to a network. The association request may include information regarding various capabilities of the station STA.

In one or more embodiments, the association request may include a field indicating whether the station STA is capable of receiving first data (latency-sensitive data).

Whether the station STA is capable of receiving the first data may indicate whether the station STA has a capability to decode the first data when the access point AP inserts the first data in the middle of a PPDU and transmits the PPDU.

For example, the field indicating whether the station STA is capable of receiving the first data may include one bit. Here, when this field has a first value (for example, logic 1), the field may indicate that the station STA is capable of receiving the first data. On the other hand, when this field has a second value (for example, logic 0), the field may indicate that the station STA is not is capable of receiving the first data. However, the disclosure is not limited thereto.

When a request for transmission of the first data to the station STA is generated during transmission of a PPDU, the access point AP may determine whether to transmit an inserted PPDU including the first data, based on whether the station STA is able to receive the first data.

When the station STA is able to receive the first data, the station STA may decode and obtain the first data which is inserted in the middle of the PPDU and then transmitted by the access point AP. Therefore, when it is determined that the station STA is able to receive the first data, the access point AP may transmit an inserted PPDU including the first data in the case where a request for transmission of the first data is generated during the transmission of the PPDU.

On the other hand, when the station STA is not able to receive the first data, the station STA may not obtain the first data which is inserted in the middle of the PPDU and then transmitted by the access point AP. Therefore, when it is determined that the station STA is not able to receive the first data, the access point AP may not transmit an inserted PPDU including the first data even though a request for transmission of the first data is generated during the transmission of the PPDU.

In operation S420, the station STA may transmit, to the access point AP, the association request generated in operation S410. Accordingly, the access point AP may receive the association request from the station STA. Here, the access point AP may receive the association request including the field indicating whether the station STA is capable of receiving the first data is able to be received.

In operation S430, the access point AP may generate an association response. The association response may be a response transmitted for an initial link setup with the station STA. The association response may include information, such as a station ID or a group ID.

The station ID may be a value for identifying the station STA, which is to receive the association response, from among other stations. When the access point AP receives an association request from a new station STA, the access point AP may allocate a station ID, which is different from those of other stations already associated, to the new station STA.

The group ID may be a value for indicating which RU is used to transmit the first data to the station STA that is to receive the association response. When the access point AP receives the association request from the station STA, the access point AP may allocate the group ID to the station STA. Here, the station STA may be allocated the same group ID as those of other stations already associated. For example, several stations may have the same group ID. As another example, a plurality of group IDs may be allocated to one station. That is, one station may have a plurality of group IDs.

In operation S440, the access point AP may transmit, to the station STA, the association response including the group ID generated in operation S430. Accordingly, the station STA may receive, from the access point AP, the association response including the group ID.

In operation S450, the access point AP may generate a PPDU. The access point AP may generate a PPDU including a first signal field and a second signal field.

In one or more embodiments, the first signal field may include a field indicating whether the first data is to be transmitted. The field indicating whether the first data is to be transmitted may be a field notifying that an inserted PPDU including the first data is to be transmitted when a request for transmission of the first data is generated during the transmission of the PPDU. Here, whether the first data is able be transmitted may refer to whether there is possibility that the first data will be transmitted.

For example, the field indicating whether the first data is to be transmitted may include one bit. Here, when this field has a first value (for example, logic value 1), the field may indicate that the inserted PPDU including the first data is to be transmitted when a request for transmission of the first data is generated during the transmission of the PPDU. On the other hand, when this field has a second value (for example, logic 0), the field may indicate that the inserted PPDU including the first data is not to be transmitted even though a request for transmission of the first data is generated during the transmission of the PPDU. However, the disclosure is not limited thereto.

In one or more embodiments, the second signal field may include a field indicating information about the allocation of an RU, a field indicating that the first data is to be transmitted via the RU, and a field indicating a group ID including an apparatus that is to receive the first data transmitted via the RU capable of transmitting the first data.

The field indicating information about the allocation of the RU may indicate how the RU is allocated in the frequency domain. The field indicating that the first data is to be transmitted may indicate that the first data is to be transmitted via the RU corresponding to the field. The field indicating a group ID may indicate a group ID including an apparatus that is to receive the first data transmitted via the RU corresponding to the field.

In one or more embodiments, the PPDU may transmit a field indicating a time point at which the first data is to be transmitted. This field may notify which symbol among symbols in a payload of the PPDU is to be used to transmit the inserted PPDU including the first data. Here, this field may be included in one of the first signal field and the second signal field.

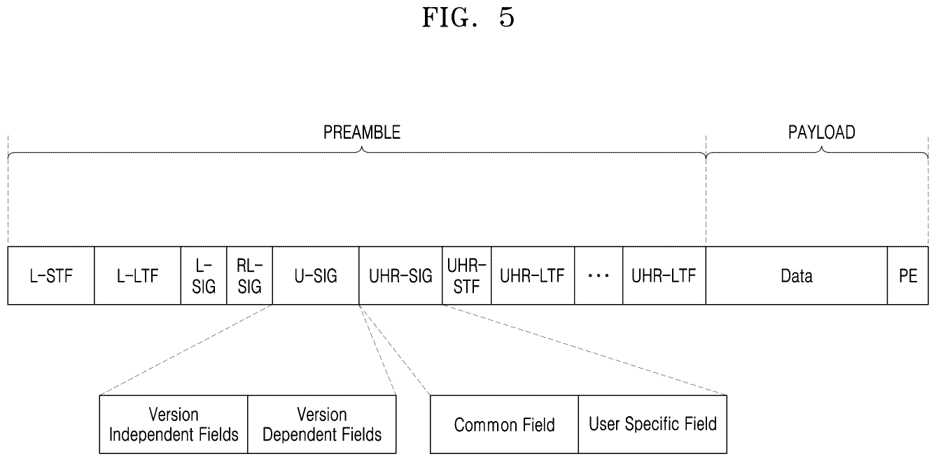

A detailed structure and an example of the PPDU including the first signal field and the second signal field as described above are described below with reference to FIG. 5 and subsequent figures thereto.

In operation S460, the access point AP may transmit, to the station STA, the PPDU that is generated in operation S450 and includes a field indicating whether the first data is to be transmitted.

While the access point AP is transmitting the PPDU in operation S460, when a request for transmission of the first data is generated, the access point AP may generate an inserted PPDU including the first data.

In one or more embodiments, the inserted PPDU may include a field indicating an ID of an apparatus that is to receive the inserted PPDU. For example, the inserted PPDU may include a field indicating the station ID of the station STA that is to receive the first data.

The access point AP may transmit the inserted PPDU including the first data at a time point at which the first data is to be transmitted.

As the access point AP transmits the PPDU, the station STA may receive the PPDU from the access point AP.

The station STA may check whether the first data is to be transmitted, by checking the field that is included in the first signal field and indicates whether the first data is to be transmitted.

When it is determined that the first data is to be transmitted, the station STA may check, in the second signal field, the field indicating information about the allocation of an RU, the field indicating that the first data is to be transmitted via the RU, and the field indicating a group ID including an apparatus that is to receive the first data that is transmitted via the RU capable of transmitting the first data, thereby checking which RU is to be used to transmit the first data.

Additionally, the station STA may check the field, which is included in one of the first signal filed and the second signal filed and indicates a time point at which the first data is to be transmitted, thereby checking the time point at which the first data is to be transmitted.

The station STA may check whether the first data is transmitted via the RU determined through the second signal field. Here, the station STA may check whether the first data is transmitted at the time point at which the first data is to be transmitted.

According to the operation method of the wireless communication system 10, as described above, the access point AP may transmit the PPDU, which includes the field indicating whether the first data is to be transmitted and the field indicating the group ID including an apparatus that is to receive the first data transmitted via the RU capable of transmitting the first data, thereby notifying the station STA of whether the first data is to be transmitted.

In addition, when a request for transmission of the first data is generated, the access point AP may transmit the inserted PPDU including the first data via the RU corresponding to the group ID, thereby allowing the first data to be quickly transmitted.

It is to be understood herebelow that, unless specified otherwise, the term “an access point” may refer to the access point AP1, AP2 or AP shown in FIGS. 1 and 4, and the term “a station” may refer to any one of the stations STA1 to STA4 and STA shown in FIGS. 1 and 4.

FIG. 5 illustrates an example of a PPDU transmitted by an access point, according to one or more embodiments.

Referring to FIG. 5, the PPDU may include a preamble, which includes training fields and signal fields, and a payload, which includes a data field and a packet extension (PE) field.

Here, the example of the PPDU, shown in FIG. 5, may be a PPDU conforming to the UHR multiple user (MU) PPDU format according to the UHR standard protocol. The disclosure may also be applied to the EHT or EHT+ standard protocol, further, to next-generation standard protocols.

The PPDU may include, in the preamble, a legacy-short training field (L-STF), a legacy-long training field (L-LTF), a legacy-signal (L-SIG) field, a repeated legacy-signal (RL-SIG) field, a U-SIG field, a UHR-SIG field, an ultrahigh reliability-short training field (UHR-STF), and an ultrahigh reliability-long training field (UHR-LTF). Hereinafter, the U-SIG field and the UHR-SIG field may be simply referred to as a U-SIG and a UHR-SIG, respectively. Hereinafter, the U-SIG field may be referred to as a first signal field, and the UHR-SIG field or a UHR-SIG content channel in the UHR-SIG field may be referred to as a second signal field, as described in reference to FIG. 4. The UHR-SIG field may be implemented to include a plurality of UHR-SIG content channels, and an example embodiment thereof is described below.

The L-STF may include a short training OFDM symbol and may be used for frame detection, automatic gain control (AGC), diversity detection, and coarse frequency/time synchronization. The L-LTF may include a long training OFDM symbol and may be used for fine frequency/time synchronization and channel estimation. The L-SIG field may be used for control information transmission and may include information about a data rate and a data length. In some embodiments, in the RL-SIG field, the L-SIG field may be repeated.

The U-SIG field (or the U-SIG) may include control information that is common to a plurality of stations that are to receive the PPDU. For example, as shown in FIG. 5, the U-SIG field may include version-independent fields and version-dependent fields. In some embodiments, the U-SIG field may further include fields respectively corresponding to a cyclic redundancy check (CRC) and a tail, and reserved bits. The version-independent fields may have static positions and bit definitions in a different generation and/or physical version. In some embodiments, unlike the UHR-SIG field described below, the U-SIG field may be modulated based on a single modulation scheme, for example, binary phase-shift keying (BPSK).

The UHR-SIG field may have a variable modulation and coding scheme (MCS) and a variable length. For example, when a PPDU is transmitted to multiple users (or a plurality of stations), the UHR-SIG field may include a common field including common control information, and a user-specific field including control information that is dependent on a user, as shown in FIG. 5. As shown in FIG. 5, while the U-SIG field may have a fixed length, the UHR-SIG field may have a variable length. The common field may include a U-SIG overflow, the total number of non-OFDMA stations (or users), and an RU allocation subfield. The user-specific field for non-MU MIMO may include an STA-ID subfield, an MCS subfield, an NSTS subfield, a beamformed subfield, and a coding subfield, and the user-specific field for MU MIMO may include an STA-ID subfield, an MCS subfield, a coding subfield, and a spatial configuration subfield. In some embodiments, the UHR-SIG field may be modulated based on one of two or more modulation schemes, for example, BPSK, quadrature binary phase-shift keying (QBPSK), and the like.

In one or more embodiments, in an area throughout the U-SIG field and the UHR-SIG field, a field indicating whether first data is to be transmitted, and a field indicating a group ID including an apparatus that is to receive the first data transmitted via an RU capable of transmitting the first data may be included. For example, the U-SIG field may include the field indicating whether the first data is to be transmitted, and the UHR-SIG field may include the field indicating the group ID including an apparatus that is to receive the first data transmitted via the RU capable of transmitting the first data.

Because the PPDU shown in FIG. 5 is only an example, the disclosure is not limited thereto, and the PPDU may variously change according to a UHR standard protocol. In addition, the field indicating whether the first data is to be transmitted, and the field indicating the group ID including an apparatus that is to receive the first data transmitted via the RU capable of transmitting the first data may be included in at least one field other than the U-SIG field and the UHR-SIG field.

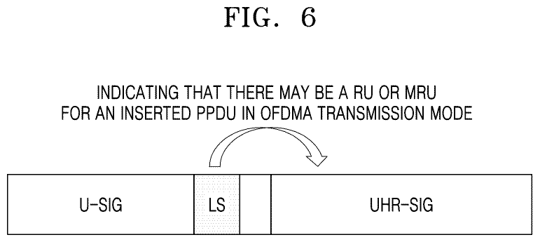

FIG. 6 illustrates an LS subfield transmitted by an access point, according to one or more embodiments.

Referring to FIG. 6, an LS subfield LS may be arranged in the U-SIG field. In one or more embodiments, the LS subfield LS may include bit data for indicating whether there is a possibility for the access point AP to transmit first data. In one or more embodiments, the LS subfield LS may be a field indicating whether the first data is to be transmitted. In an example, the bit data may include one bit. For example, the LS subfield LS may indicate whether there is an RU or MRU for an inserted PPDU in an OFDMA transmission mode.

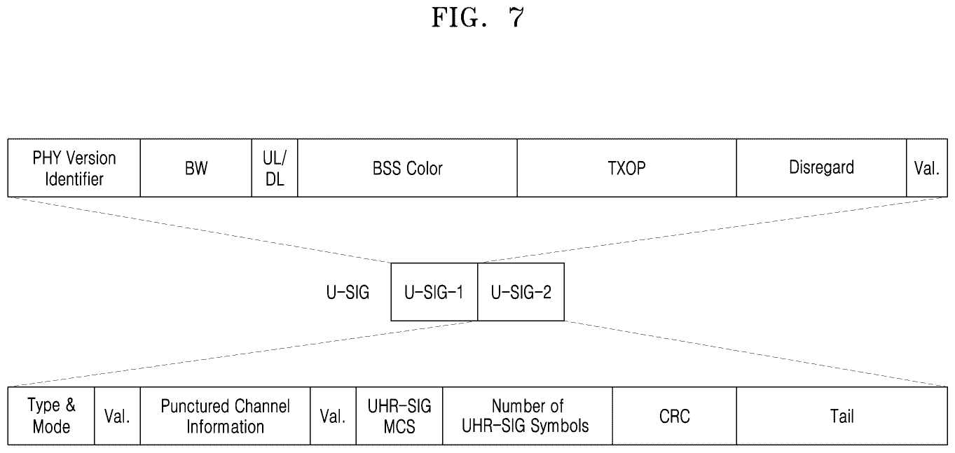

FIG. 7 illustrates an example of a U-SIG field in a PPDU transmitted by an access point, according to one or more embodiments.

Referring to FIG. 7, the U-SIG field may include a U-SIG-1 and a U-SIG-2.

The U-SIG-1 may include, as version-independent fields, a physical version identifier field, a bandwidth field (e.g., “BW”), an uplink (UL)/downlink (DL) field, a basic service set (BSS) color field, a transmit opportunity (TXOP) field, and reserved fields (e.g., “Disregard” and “Val.”).

The U-SIG-2 may include, as version-dependent fields, a PPDU type & compression mode field (e.g., “Type & Mode”), a punctured channel information field, a UHR-SIG MCS field, a number of UHR-SIG symbols field, a CRC field, a tail field (e.g., “Tail”), and a reserved field (e.g., “Val.”).

In one or more embodiments, the LS subfield LS may be arranged in the reserved fields (e.g., “Disregard” and “Val.”). Here, the LS subfield LS may be implemented by using at least one of bits that are included in the reserved fields (e.g., “Disregard” and “Val.”).

In one or more other embodiments, the LS subfield LS may be implemented by using at least one of bits of the reserved field (e.g., “Val.”) of the U-SIG-2. Here, the LS subfield LS may be implemented by using at least one of the bits that are included in the reserved field (e.g., “Val.”).

In one or more embodiments, an access point AP may indicate that the access point operates in an OFDMA transmission mode, through the UL/DL field and the PPDU type & compression mode field (e.g., “Type & Mode”), and may indicate whether an inserted PPDU including first data is to be transmitted, through the LS subfield LS.

In one or more embodiments, a station may extract values of the UL/DL field and the PPDU type & compression mode field (e.g., “Type & Mode”) and, based on the extracted values, may check first that the access point operates in an OFDMA transmission mode. Next, the station may extract a value of the LS subfield LS and, based on the extracted value, may check whether the inserted PPDU including the first data is to be transmitted.

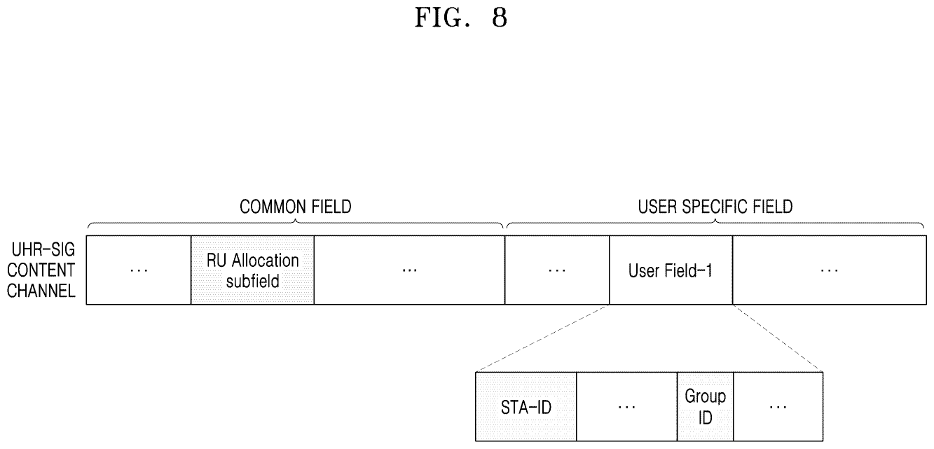

FIG. 8 illustrates an example of a UHR-SIG field in a PPDU transmitted by an access point, according to one or more embodiments.

Referring to FIG. 8, the UHR-SIG field may include a common field and a user-specific field.

The common field may include an RU allocation subfield.

The RU allocation subfield may indicate how an RU is allocated in the frequency domain. The RU allocation subfield may indicate one of RUs allocated in the frequency domain. A user field corresponding to the RU indicated by the RU allocation subfield may be in the user-specific field. In one or more embodiments, the RU allocation subfield may be a field indicating information about the allocation of the RU.

The user field may include a station ID (which is referred to as STA-ID, hereinafter) subfield and a group ID subfield.

The STA-ID subfield may indicate an ID of a station that is to receive data transmitted via the RU corresponding to the user field.

In one or more embodiments, the STA-ID subfield may be used as a field indicating that first data is to be transmitted. For example, by setting the value of the STA-ID subfield as a preset specific value (for example, 2044), the access point AP may indicate that the first data is to be transmitted via the RU corresponding to the user field.

In one or more embodiments, when the STA-ID subfield indicates that the first data is to be transmitted via the RU corresponding to the user field, the group ID subfield may indicate a group ID of a group including an apparatus that is to receive the first data transmitted via the RU corresponding to the user field. For example, the group ID subfield may be a field indicating the group ID of a group including an apparatus that is to receive the first data transmitted via the RU capable of transmitting the first data.

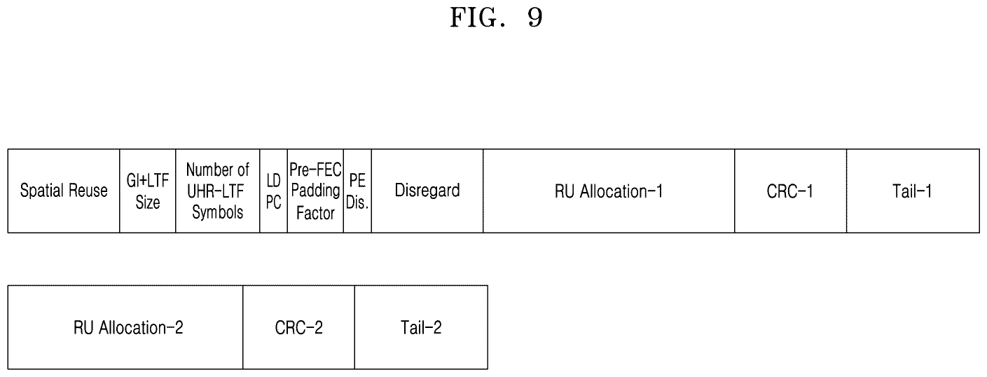

FIG. 9 illustrates an example of a common field of a UHR-SIG field in a PPDU transmitted by an access point, according to one or more embodiments.

Referring to FIG. 9, in an OFDMA transmission mode, a common field of a UHR-SIG content channel may include a Spatial Reuse subfield, a GI+LTF size subfield, a Number of UHR-LTF Symbols subfield, an LDPC extra symbol segment subfield (e.g., “LDPC”), a Pre-FEC padding factor subfield, a PE disambiguity subfield (e.g., “PE Dis.”), a reserved subfield (e.g., “Disregard”), a first RU allocation subfield (e.g., “RU Allocation-1”), a CRC-1 subfield, a Tail-1 subfield, a second RU allocation subfield (e.g., “RU Allocation-2”), a CRC-2 subfield, and a Tail-2 subfield. According to a value of a bandwidth field of a U-SIG field, for example, a bandwidth for communication between an access point and a station, the number of RU allocation subfields, the number of CRC subfields, and the number of Tail subfields may each increase or decrease.

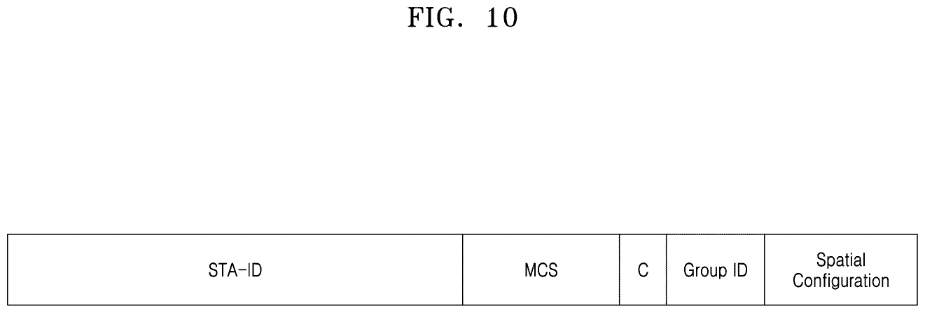

FIG. 10 illustrates an example of a user-specific field of a UHR-SIG field in a PPDU transmitted by an access point, according to one or more embodiments.

Referring to FIG. 10, in an OFDMA transmission mode, a user-specific field of a UHR-SIG content channel may include an STA-ID subfield, an MCS subfield, a coding subfield C, a Group ID subfield, and a Spatial Configuration subfield.

In one or more embodiments, the Group ID subfield may be arranged between the coding subfield C and the Spatial Configuration subfield. However, the disclosure is not limited thereto, and there may be various examples of arranging the Group ID subfield.

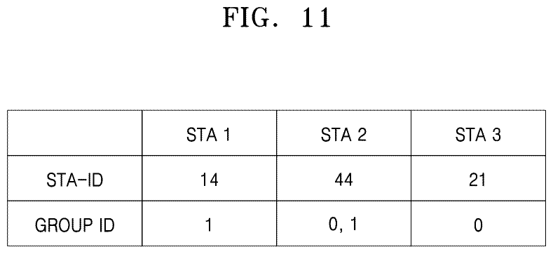

FIG. 11 illustrates respective examples of a station ID and a group ID, which are allocated to a plurality of stations in a wireless communication system, according to one or more embodiments.

Referring to FIG. 11, a table shows STA-IDs and group IDs, which are allocated to first to third stations STA1 to STA3. Here, although FIG. 11 illustrates an example in which the number of stations is 3, the disclosure is not limited thereto. However, an example in which the number of stations is 3 is mainly described below.

As an access point receives an association request from each of the first to third stations STA1 to STA3, the access point may allocate an STA-ID and a group ID. The access point may transmit an association response including the STA-ID and the group ID, which are allocated, to each of the first to third stations STA1 to STA3.

The first station STA1 may have an STA-ID of 14 and a group ID of 1.

The second station STA2 may have an STA-ID of 44 and group IDs of 0 and 1. As such, a plurality of group IDs may be allocated to one station. In addition, as such, the same group ID as the group ID allocated to another station may be allocated.

The third station STA3 may have an STA-ID of 21 and a group ID of 0.

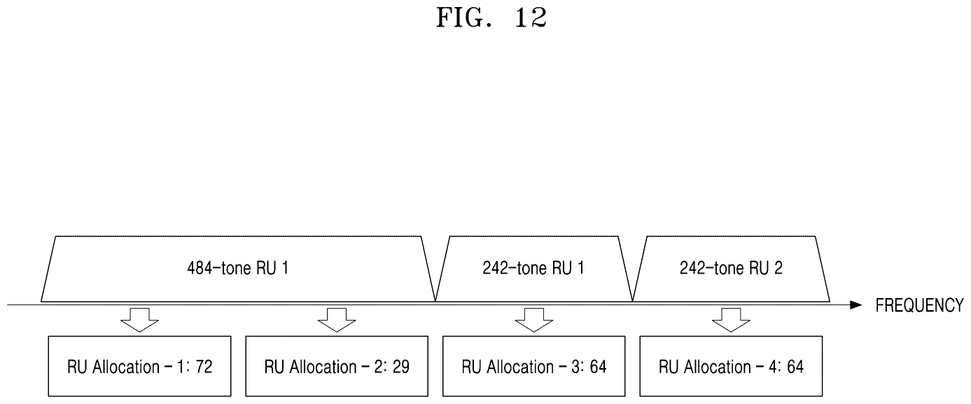

FIG. 12 illustrates an example of a resource unit configuration when a bandwidth allocated to a wireless communication system is 80 MHz, according to one or more embodiments.

Referring to FIG. 12, when the wireless communication system operates in an OFDMA transmission mode at a bandwidth of 80 MHz, a frequency band may include a 484-tone RU1, a 242-tone RU1, and a 242-tone RU2. Here, although FIG. 12 illustrates one or more embodiments in which the wireless communication system operates in an OFDMA transmission mode at a bandwidth of 80 MHz, the disclosure is not limited thereto. However, one or more embodiments in which the wireless communication system operates in an OFDMA transmission mode at a bandwidth of 80 MHz is mainly described below.

A first RU allocation subfield (e.g., “RU Allocation-1”) and a second RU allocation subfield (e.g., “RU Allocation-2”) may indicate the 484-tone RU1. In the embodiment of FIG. 12, the first RU allocation subfield (e.g., “RU Allocation-1”) may have a value (for example, 72) indicating that the number of stations or groups allocated the 484-tone RU1 is 1. In addition, the second RU allocation subfield (e.g., “RU Allocation-2”) may have a value (for example, 29) indicating that the number of stations or groups allocated the 484-tone RU1 is 0. Here, according to the first RU allocation subfield (e.g., “RU Allocation-1”) and the second RU allocation subfield (e.g., “RU Allocation-2”), the total number of stations allocated the 484-tone RU1 may be 1 (e.g., 1+0).

The third RU allocation subfield (e.g., “RU Allocation-3”) may indicate the 242-tone RU1. In the embodiment of FIG. 12, the third RU allocation subfield (e.g., “RU Allocation-3”) may have a value (for example, 64) indicating that the number of stations or groups allocated the 242-tone RU1 is 1.

A fourth RU allocation subfield (e.g., “RU Allocation-4”) may indicate the 242-tone RU2. In the embodiment of FIG. 12, the fourth RU allocation subfield (e.g., “RU Allocation-4”) may have a value (for example, 64) indicating that the number of stations or groups allocated the 242-tone RU2 is 1.

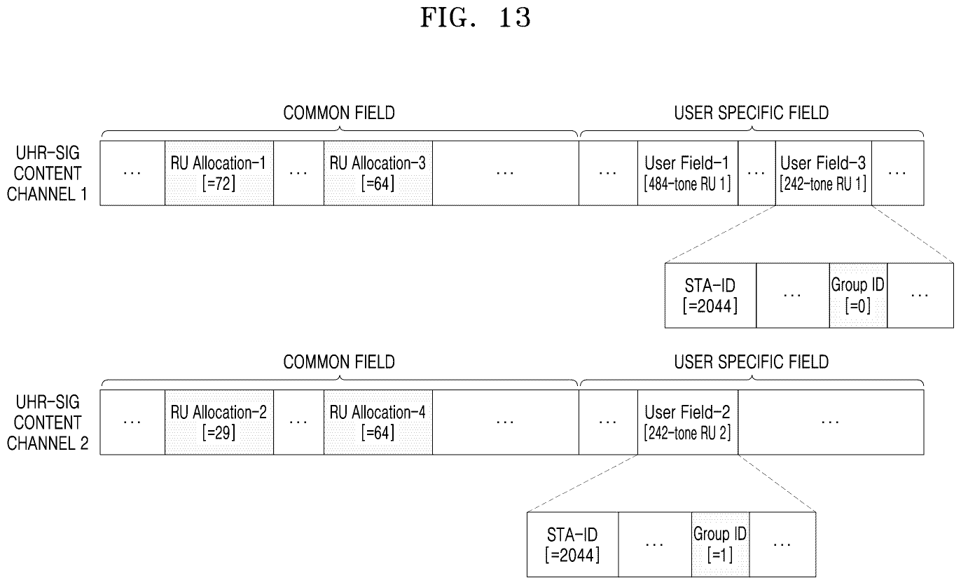

FIG. 13 illustrates an example of a UHR-SIG field in a PPDU transmitted by an access point, when a resource unit configuration is the same as the example of FIG. 12.

Referring to FIG. 13, there are a first UHR-SIG content channel (e.g., “UHR-SIG CONTENT CHANNEL 1”) and a second UHR-SIG content channel (e.g., “UHR-SIG CONTENT CHANNEL 2”) in the UHR-SIG field.

At a bandwidth of 80 MHz, the UHR-SIG field may include four UHR-SIG content channels in total. Here, the four UHR-SIG content channels in total may include two first UHR-SIG content channels (e.g., “UHR-SIG CONTENT CHANNEL 1”) and two second UHR-SIG content channels (e.g., “UHR-SIG CONTENT CHANNEL 2”). That is, each of the first UHR-SIG content channel (e.g., “UHR-SIG CONTENT CHANNEL 1”) and the second UHR-SIG content channel (e.g., “UHR-SIG CONTENT CHANNEL 2”) may be included twice in the UHR-SIG field.

A common field of the first UHR-SIG content channel (e.g., “UHR-SIG CONTENT CHANNEL 1”) may include a first RU allocation subfield (e.g., “RU Allocation-1”) and a third RU allocation subfield (e.g., “RU Allocation-3”). A user-specific field of the first UHR-SIG content channel (e.g., “UHR-SIG CONTENT CHANNEL 1”) may include a first user field (e.g., “User Field-1”) and a third user field (e.g., “User Field-3”).

Here, the first RU allocation subfield (e.g., “RU Allocation-1”) has a value of 72, which indicates that the number of stations or groups corresponding thereto is 1, and may correspond to the first user field (e.g., “User Field-1”). In addition, the third RU allocation subfield (e.g., “RU Allocation-3”) has a value of 64, which indicates that the number of stations or groups corresponding thereto is 1, and may correspond to the third user field (e.g., “User Field-3”).

A common field of the second UHR-SIG content channel (e.g., “UHR-SIG CONTENT CHANNEL 2”) may include a second RU allocation subfield (e.g., “RU Allocation-2”) and a fourth RU allocation subfield (e.g., “RU Allocation-4”). A user-specific field of the second UHR-SIG content channel (e.g., “UHR-SIG CONTENT CHANNEL 2”) may include a second user field (e.g., “User Field-2”).

Here, the second RU allocation subfield (e.g., “RU Allocation-2”) has a value of 29, which indicates that the number of stations or groups corresponding thereto is 0, and may have no user field corresponding thereto. In addition, the fourth RU allocation subfield (e.g., “RU Allocation-4”) has a value of 64, which indicates that the number of stations or groups corresponding thereto is 1, and may correspond to the second user field (e.g., “User Field-2”).

In one or more embodiments, an STA-ID subfield of the third user field (e.g., “User Field-3”) may have a value of 2044, which is a preset specific value, and this may indicate that first data is to be transmitted via the 242-tone RU1 corresponding to the third user field (e.g., “User Field-3”). Here, a group ID subfield of the third user field (e.g., “User Field-3”) may have a value of 0, and this may indicate that the first data needing to be transmitted to the second station STA2 and the third station STA3, each having a group ID of 0, is to be transmitted via the 242-tone RU1.

In addition, in one or more embodiments, an STA-ID subfield of the second user field (e.g., “User Field-2”) may have a value of 2044, which is a preset specific value, and this may indicate that the first data is to be transmitted via the 242-tone RU2 corresponding to the second user field (e.g., “User Field-2”). Here, a group ID subfield of the second user field (e.g., “User Field-2”) may have a value of 1, and this may indicate that the first data needing to be transmitted to the first station STA1 and the second station STA2, each having a group ID of 1, is to be transmitted via the 242-tone RU2.

However, FIG. 13 is only an example, and the disclosure is not limited thereto.

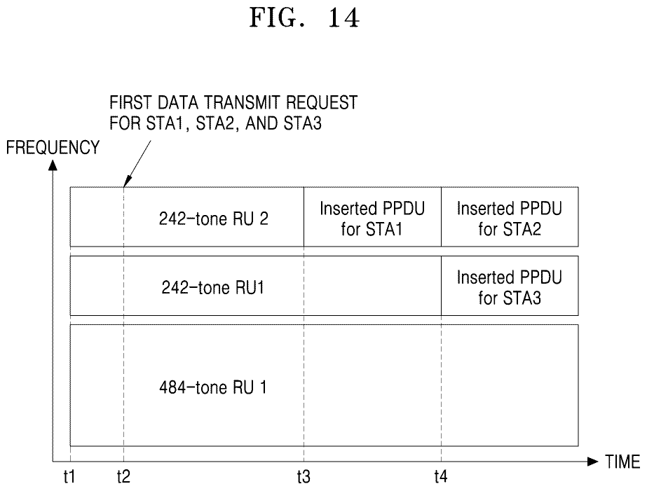

FIG. 14 illustrates an example of transmitting an inserted PPDU through a PPDU that is being transmitted by an access point, when a resource unit configuration is the same as the example of FIG. 12.

Referring to FIG. 14, one or more embodiments, in which an access point transmits an inserted PPDU including first data to the first to third stations STA1 to STA3, is shown.

At a first time point t1, the access point may start to transmit a PPDU to the first to third stations STA1 to STA3.

At a second time point t2, a request for transmission of the first data needing to be transmitted from the access point to each of the first to third stations STA1 to STA3 may be generated.

A group ID corresponding to the first station STA1 may be 1 as in the embodiment of FIG. 11. Here, an RU corresponding to a second user field (e.g., “User Field-2”), in which an STA-ID subfield has a value of 2044 and a group ID subfield has a value of 1, may be a 242-tone RU2. Therefore, the first data needing to be transmitted to the first station STA1 may be transmitted via the 242-tone RU2.

Group IDs corresponding to the second station STA2 may be 0 and 1 as in the embodiment of FIG. 11. Here, an RU corresponding to the second user field (e.g., “User Field-2”), in which the STA-ID subfield has a value of 2044 and the group ID subfield has a value of 1, may be the 242-tone RU2. In addition, an RU corresponding to a third user field (e.g., “User Field-3”), in which an STA-ID subfield has a value of 2044 and a group ID subfield has a value of 0, may be a 242-tone RU1. Therefore, the first data needing to be transmitted to the second station STA2 may be transmitted via one of the 242-tone RU1 and the 242-tone RU2. In the embodiment of FIG. 14, the first data needing to be transmitted to the second station STA2 may be transmitted via the 242-tone RU2.

A group ID corresponding to the third station STA3 may be 0 as in the embodiment of FIG. 11. Here, an RU corresponding to the third user field (e.g., “User Field-3”), in which the STA-ID subfield has a value of 2044 and the group ID subfield has a value of 0, may be the 242-tone RU1. Therefore, the first data needing to be transmitted to the third station STA3 may be transmitted via the 242-tone RU1.

At a third time point t3, the access point may transmit, to the first station STA1, a first inserted PPDU (e.g., “Inserted PPDU for STA1”) including the first data needing to be transmitted to the first station STA1, via the 242-tone RU2.

Next, at a fourth time point t4, the access point may transmit, to the second station STA2, a second inserted PPDU (e.g., “Inserted PPDU for STA2”) including the first data needing to be transmitted to the second station STA2, via the 242-tone RU2. In addition, at the fourth time point t4, the access point may transmit, to the third station STA3, a third inserted PPDU (e.g., “Inserted PPDU for STA3”) including the first data needing to be transmitted to the third station STA3, via the 242-tone RU1.

Here, the third time point t3 and the fourth time point t4 may be set to be matched with a value of a field indicating a time point at which the first data in the PPDU is to be transmitted. For example, when the field indicating the time point at which the first data is to be transmitted has a first value (for example, 1), the inserted PPDU may be transmitted starting from (5n+1)-th symbol (where n is a natural number) among symbols that are included in a payload in the PPDU. As another example, when the field indicating the time point at which the first data in the PPDU is to be transmitted has a second value (for example, 0), the inserted PPDU may be transmitted starting from (10n+1)-th symbol among the symbols that are included in the payload in the PPDU.

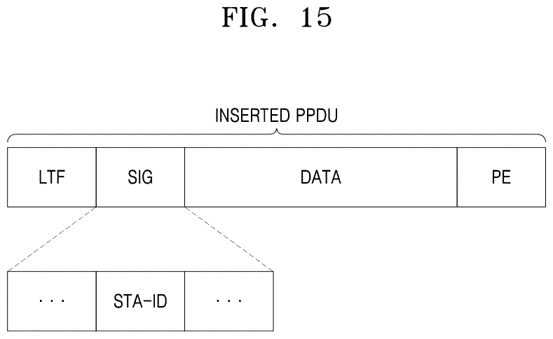

FIG. 15 illustrates an example of an inserted PPDU transmitted by an access point, according to one or more embodiments.

Referring to FIG. 15, the inserted PPDU may include a long training field LTF, a signal field SIG, a data field DATA, and a PE field.

The long training field LTF may include a certain data sequence for a target station, which is to receive the inserted PPDU, to sense the inserted PPDU. For example, the certain data sequence may be consistent with a reference sequence stored in the target station.

The signal field SIG may include a plurality of fields required for the target station to decode data in the data field DATA. For example, the signal field SIG may include an LDPC extra symbol segment subfield, a Pre-FEC padding factor subfield, a PE disambiguity subfield, an STA-ID subfield, an MCS subfield, a number of spatial streams (NSS) subfield, a Beamformed subfield, a Coding subfield, and the like.

In one or more embodiments, the signal field SIG may include an STA-ID subfield. The value of the STA-ID subfield may include an STA-ID of the target station that is to receive the inserted PPDU. For example, in the case where the STA-ID and the group ID are allocated as in the embodiment of FIG. 11, when the value of the STA-ID subfield is 14, the target station that is to receive the inserted PPDU may be the first station STA1. In addition, when the value of the STA-ID subfield is 44, the target station that is to receive the inserted PPDU may be the second station STA2. As such, through the value of the STA-ID subfield that is included in the signal field SIG of the inserted PPDU, the station STA may identify whether the inserted PPDU, which is transmitted via an RU corresponding to the group ID allocated to the station STA itself, includes the first data to be transmitted to the station STA itself.

In one or more embodiments, the data field DATA may include the first data.

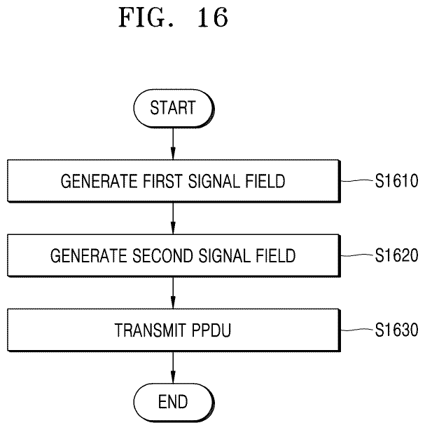

FIG. 16 is a flowchart illustrating an operation method of an access point, according to one or more embodiments.

Referring to FIG. 16, in operation S1610, the access point may generate a first signal field.

The first signal field may include a field (e.g., the LS subfield of FIG. 6) indicating whether first data is to be transmitted. By doing this, the access point may transfer, to a station, whether the first data is to be transmitted.

In operation S1620, the access point may generate a second signal field.

The second signal field may include a field (e.g., the RU allocation subfield of FIG. 8) indicating information about allocation of an RU, a field (e.g., the STA-ID subfield of FIG. 8) indicating that first data is able to be transmitted via the RU, and a field (e.g., the group ID subfield of FIG. 8) indicating a group ID including an apparatus that is to receive the first data transmitted via the RU capable of transmitting the first data. The access point may transfer whether the first data is to be transmitted, to the station via the field indicating whether the first data is to be transmitted. By doing this, the access point may transfer, to the station, the RU capable of transmitting the first data.

Additionally, the second signal field may include a field indicating a time point at which the first data is to be transmitted. By doing this, the access point may transfer, to the station, a time point at which the first data is to be transmitted. However, unlike this, the field indicating the time point at which the first data is to be transmitted may be included in the first signal field, and in this case, the field indicating the time point at which the first data is to be transmitted may be generated in operation S1610.

In operation S1630, the access point may transmit a PPDU.

The access point may transmit the PPDU, which includes the first signal field generated in operation S1610 and the second signal field generated in operation S1620. First, the access point may transmit the first signal field including the field indicating whether the first data is to be transmitted. Next, the access point may transmit the second signal field, which includes the field indicating information about the allocation of the RU, the field indicating that the first data is to be transmitted via the RU, and the field indicating the group ID including an apparatus that is to receive the first data transmitted via the RU capable of transmitting the first data. Additionally, the access point may transmit, via one of the first signal field and the second signal field, the time point at which the first data is to be transmitted.

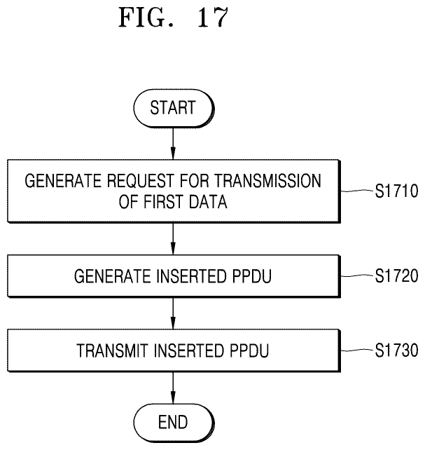

In operation S1630, while the access point is transmitting the PPDU, when a request for transmission of the first data is generated, the access point may transmit an inserted PPDU including the first data. A method, performed by the access point, of transmitting the inserted PPDU may be described in more detail with reference to FIG. 17.

FIG. 17 is a flowchart illustrating a method, performed by an access point, of transmitting an inserted PPDU, according to one or more embodiments.

Referring to FIG. 17, in operation S1710, a request for transmission of first data may be generated in the access point.

Additionally, when the request for transmission of the first data is generated, the access point may determine whether to transmit an inserted PPDU including the first data, based on whether a station needing to receive the first data is able to receive the first data. Here, when the station is capable of receiving the first data, the access point may perform operation S1720 and subsequent operations thereto. On the other hand, when the station is not capable of receiving the first data, the access point may not perform operation S1720 and the subsequent operations thereto.

In operation S1720, the access point may generate an inserted PPDU.

The inserted PPDU may include a field (e.g., the STA-ID subfield in the signal field SIG of FIG. 15) indicating an ID of an apparatus that is to receive the inserted PPDU, and the first data (which is included in, for example, the data field DATA of FIG. 15). By doing this, the access point may transfer, to an intended station, the inserted PPDU including the first data.

In operation S1730, the access point may transmit the inserted PPDU. The access point may transmit the inserted PPDU including the first data at a time point at which the first data is to be transmitted.

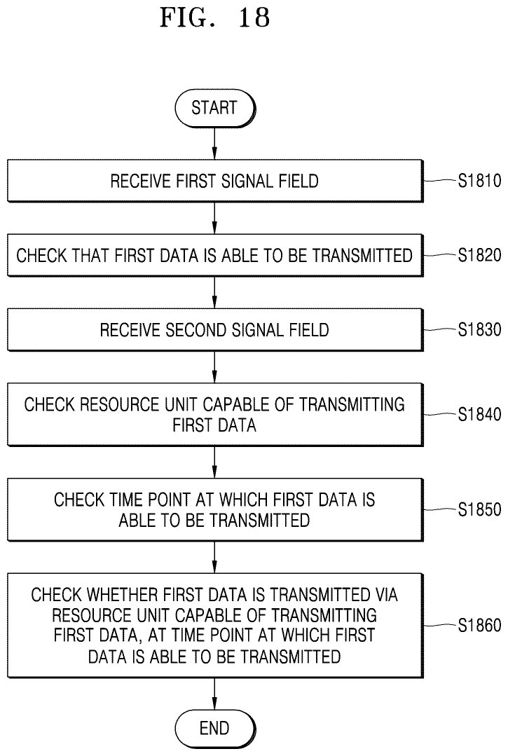

FIG. 18 is a flowchart illustrating an operation method of a station, according to one or more embodiments.

Referring to FIG. 18, an operation, in which the station receives a PPDU transmitted from an access point, is illustrated.

In operation S1810, the station may identify a first signal field included in the PPDU. Here, the first signal field may include a field (e.g., the LS subfield of FIG. 6) indicating whether first data is to be transmitted.

In operation S1820, the station may check that the first data is to be transmitted. The station may decode the field (e.g., the LS subfield of FIG. 6), which is included in the first signal field and indicates whether the first data is to be transmitted, thereby checking whether the first data is to be transmitted. Operation S1830 and subsequent operations thereto are described mainly as to the case where it is checked that the first data is to be transmitted.

In operation S1830, the station may identify a second signal field included in the PPDU. Here, the second signal field may include a field (e.g., the RU allocation subfield of FIG. 8) indicating information about the allocation of an RU, a field (e.g., the STA-ID subfield of FIG. 8) indicating that the first data is to be transmitted via the RU, and a field (e.g., the group ID subfield of FIG. 8) indicating a group ID including an apparatus that is to receive the first data transmitted via the RU capable of transmitting the first data.

In operation S1840, the station may check the RU capable of transmitting the first data. The station may decode the field (e.g., the RU allocation subfield of FIG. 8) included in the second signal field and indicating information about the allocation of the RU, the field (e.g., the STA-ID subfield of FIG. 8) included in the second signal field and indicating that the first data is to be transmitted via the RU, and the field (e.g., the group ID subfield of FIG. 8) included in the second signal field and indicating the group ID including an apparatus that is to receive the first data transmitted via the RU capable of transmitting the first data, thereby checking the RU capable of transmitting the first data.

In operation S1850, the station may check a time point at which the first data is to be transmitted. The station may decode a field, which is included in one of the first signal field and the second signal field and indicates the time point at which the first data is to be transmitted, thereby checking the time point at which the first data is to be transmitted.

In operation S1860, the station may check whether the first data is transmitted via the RU capable of transmitting the first data, at the time point at which the first data is to be transmitted.

For example, the station may check whether data, which is transmitted via the RU capable of transmitting the first data, at the time point at which the first data is to be transmitted, includes a long training field LTF, thereby checking whether an inserted PPDU is transmitted. When it is determined that the data includes the long training field LTF, the station may check whether the value of the STA-ID subfield in the signal field SIG that is subsequent to the long training field LTF is identical to the value of the STA-ID of the station itself. When the value of the STA-ID subfield is identical to the of the STA-ID of the station itself, the station may determine that the first data is transmitted via the RU capable of transmitting the first data, at the time point at which the first data is to be transmitted, and may perform decoding the data field DATA subsequent to the signal field SIG, thereby obtaining the first data.

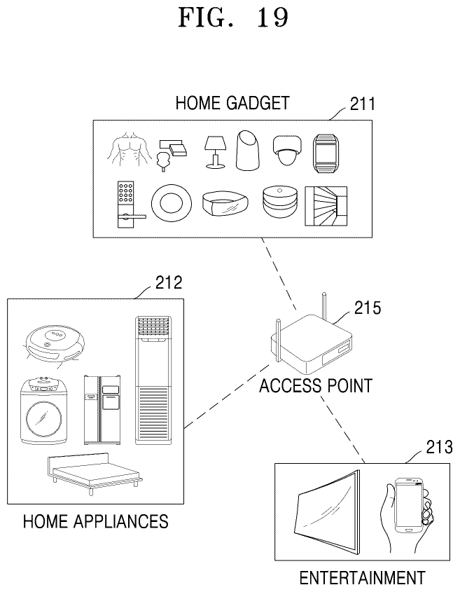

FIG. 19 illustrates examples of an apparatus for wireless communication, according to one or more embodiments.

Referring to FIG. 19, an IoT network system may include home gadgets 211, home appliances 212, entertainment devices 213, and an access point 215.

Like the access point described above with reference to FIGS. 1 to 18, a transmission apparatus, which is included in each of the home gadgets 211, the home appliances 212, and the entertainment devices 213, may transmit a PPDU, which includes a field indicating whether first data is to be transmitted and a field indicating a group ID including an apparatus that is to receive the first data transmitted via an RU capable of transmitting the first data. By doing this, the access point may notify the station of whether the first data is to be transmitted.

In addition, like the access point described above with reference to FIGS. 1 to 18, the transmission apparatus, which is included in each of the home gadgets 211, the home appliances 212, and the entertainment devices 213, may transmit an inserted PPDU including the first data via the RU corresponding to the group ID, when a request for transmission of the first data is generated. By doing this, the first data may be quickly transmitted.

While the disclosure has been particularly shown and described with reference to embodiments thereof, it will be understood that various changes in form and details may be made therein without departing from the spirit and scope of the following claims.

What is claimed is:

1. An operation method in a wireless network, the operation method comprising:
receiving, at a first apparatus, an association request from a second apparatus;
in response to the association request, transmitting, from the first apparatus to the second apparatus, an association response comprising information about the second apparatus; and
transmitting, from the first apparatus to the second apparatus, a physical layer protocol data unit (PPDU), which comprises first information about whether first data is to be transmitted and second information about an apparatus that is to receive the first data transmitted via a resource unit capable of transmitting the first data.

2. The operation method of claim 1, wherein the PPDU comprises a first signal field comprising the first information.

3. The operation method of claim 1, wherein the PPDU comprises a second signal field comprising a field indicating information about allocation of the resource unit, a field indicating that the first data is to be transmitted via the resource unit, and a field indicating a group identification (ID) comprising the second information.

4. The operation method of claim 1, wherein the transmitting the PPDU comprises, based on a request for transmission of the first data being generated while the PPDU is being transmitted, transmitting an inserted PPDU comprising the first data via the resource unit that corresponds to a group identification (ID) comprising information about the apparatus that is to receive the first data.

5. The operation method of claim 4, wherein the PPDU comprises information about an identifier (ID) of an apparatus that is to receive the inserted PPDU.

6. The operation method of claim 1, wherein the PPDU comprises information about a time point at which the first data is able to be transmitted.

7. The operation method of claim 6, wherein the transmitting the PPDU comprises, based on a request for transmission of the first data being generated while the PPDU is being transmitted, transmitting an inserted PPDU comprising the first data via the resource unit that corresponds to a group identification (ID) comprising information about the apparatus that is to receive the first data, at the time point at which the first data is to be transmitted.

8. The operation method of claim 1, wherein the association request comprises third information about whether the second apparatus is capable of receiving the first data.

9. The operation method of claim 8, wherein the transmitting the PPDU comprises, based on a request for transmission of the first data to the second apparatus being generated while the PPDU is being transmitted, determining whether to transmit an inserted PPDU comprising the first data, based on the third information.

10. The operation method of claim 9, wherein the transmitting the PPDU further comprises, based on the third information, transmitting the inserted PPDU comprising the first data via the resource unit corresponding to a group identification (ID) comprising information about the apparatus that is to receive the first data.

11. An operation method in a wireless network, the operation method comprising:
transmitting an association request from a second apparatus to a first apparatus;
in response to the association request, receiving, at the second apparatus from the first apparatus, an association response comprising information about the second apparatus; and
receiving, at the second apparatus from the first apparatus, a physical layer protocol data unit (PPDU), which comprises first information about whether first data is to be transmitted and second information about an apparatus that is to receive the first data transmitted via a resource unit capable of transmitting the first data.

12. The operation method of claim 11, wherein the PPDU comprises a first signal field comprising the first information.

13. The operation method of claim 11, wherein the PPDU comprises a second signal field comprising a field indicating information about allocation of the resource unit, a field indicating that the first data is to be transmitted via the resource unit, and a field indicating a group identification (ID) comprising the second information.

14. The operation method of claim 11, wherein the receiving the PPDU comprises:
checking whether the first data is to be transmitted; and,
based on a determination that the first data is to be transmitted, checking whether the first data is transmitted via the resource unit corresponding to the second apparatus.

15. The operation method of claim 11, wherein the PPDU comprises information about a time point at which the first data is able to be transmitted.

16. The operation method of claim 15, wherein the receiving the PPDU further comprises:
checking whether the first data is to be transmitted; and,
based on a determination that the first data is to be transmitted, checking whether the first data is transmitted via the resource unit corresponding to the second apparatus at the time point at which the first data is able to be transmitted.

17. The operation method of claim 11, wherein the transmitting the association request comprises transmitting a field indicating whether the second apparatus is capable of receiving the first data.

18. A first apparatus configured to communication with a second apparatus in a wireless network, the first apparatus comprising:
a processing circuitry configured to generate a first signal field and a second signal field, the first signal field comprising a field indicating whether first data is to be transmitted, and the second signal field comprising a field indicating information about allocation of a resource unit, a field indicating that the first data is to be transmitted via the resource unit, and a field indicating information about an apparatus that is to receive the first data transmitted via the resource unit capable of transmitting the first data; and
a transceiver configured to transmit, to the second apparatus, a physical layer protocol data unit (PPDU) comprising the first signal field and the second signal field.

19. The first apparatus of claim 18, wherein the processing circuitry is further configured to, based on a request for transmission of the first data being generated while the PPDU is being transmitted, generate an inserted PPDU comprising the first data.

20. The first apparatus of claim 19, wherein the processing circuitry is further configured to, based on the request for transmission of the first data being generated while the PPDU is being transmitted, control the transceiver to transmit the inserted PPDU comprising the first data via the resource unit corresponding to the apparatus that is to receive the first data, at a time point at which the first data is to be transmitted.
